(19) United States
(12) Patent Application Publication
(10) Pub. No.: US 2025/0343629 A1
(43) Pub. Date: Nov. 6, 2025

(54) ROBUST RETRANSMISSIONS AT MEDIUM ACCESS CONTROL LAYER FOR ULTRA HIGH READABILITY

(71) Applicant: SAMSUNG ELECTRONICS CO., LTD., Suwon-si (KR)

(72) Inventors: Abhishek CHATURVEDI, Bangalore (IN); Karthik Srinivasa GOPALAN, Bangalore (IN); Manasi EKKUNDI, Bangalore (IN)

(21) Appl. No.: 19/208,504

(22) Filed: May 14, 2025

Related U.S. Application Data
(63) Continuation of application No. PCT/KR2025/005870, filed on Apr. 30, 2025.

(30) Foreign Application Priority Data
May 3, 2024 (IN) 202441035203
Feb. 28, 2025 (IN) 202441035203

(51) Int. Cl. H04L 1/08; H04B 17/309; H04B 17/318

(52) U.S. Cl. CPC H04L 1/08; H04B 17/318; H04B 17/346

(57) ABSTRACT

Embodiments herein relate to a method and access point multi-link device (AP MLD) for robust retransmissions at a medium access control (MAC) layer for ultra-high reliability (UHR). The method includes transmitting a multi-link capability information element to a non-AP MLD indicating support for cross-link retransmission. Further, the method includes setting a traffic identifier (TID) to-link mapping (TTLM) to all supported links for retransmissions of the AP MLD. The TTLM is applicable for both an intra-AP MLD operation and an inter-AP MLD operation. Further, the method includes transmitting the control information to the non-AP MLD to facilitate the cross-link retransmission. The control information includes all the supported links for retransmissions of the AP MLD.

### CROSS REFERENCE TO RELATED APPLICATIONS

This application is a continuation application of International Application No. PCT/KR2025/005870 designating the United States, filed on Apr. 30, 2025 in the Korean Patent Office and claiming priority to Indian Provisional Application 202441035203 filed on May 3, 2024, and Indian Complete Patent Application No. 202441035203 filed on Feb. 28, 2025, all of which are incorporated by reference herein in their entireties.

### TECHNICAL FIELD

This disclosure relates to a wireless communication system, and more particularly, to robust retransmissions at a Medium Access Control (MAC) layer for Ultra High Reliability (UHR).

### BACKGROUND

In the rapidly advancing world of wireless communication, Wi-Fi 7, officially known as IEEE 802.11be, marks a major leap forward in performance, reliability, and efficiency. A standout feature of Wi-Fi 7 is Multi-Link Operation (MLO), enabling devices to use multiple frequency bands and channels at the same time. For example, the device can use multiple frequency bands, including but not limited, a 2.4 GHz, 5 GHz, and 6 GHz bands. By using MLO, devices can dynamically choose the best link for communication based on current network conditions.

Despite the promise of MLO, there are some challenges and limitations, especially when it comes to retransmitting data at the Medium Access Control (MAC) layer. Retransmissions ensure data frames arrive correctly, rectifying issues like errors or collisions during transmission. However, existing methods for retransmission in Wi-Fi 7 are deficient.

Currently, when retransmitting data frames at the MAC layer, all active links used for the process between multi-radio non-Access Point (AP) Multi-Link Devices (MLDs) and AP MLDs are often tied to a single serving AP MLD. This setup limits the flexibility and efficiency of retransmissions. Further, data frames for specific applications or those with a Quality of Service (QoS) requirement are tied to a Traffic Identifier (TID). Each TID is linked to a subset of links through a procedure called TID to Link Mapping (TTLM). As a result, the transmission and retransmission of these frames are restricted to the preassigned links for each TID.

Other factors make retransmissions even more complex. These include limits on the retransmission buffer size, the expiration of data frame lifetimes (e.g., of MAC Protocol Data Unit (MPDU)/Aggregate MAC PDU (A-MPDU)), retry count restrictions, and the eventual discarding of frames after too many retries. For individually addressed frames without a Block Acknowledgment (BA) agreement for a TID, no new transmissions can occur until ongoing retransmissions are either successfully completed or fail altogether.

Further complications arise due to the changing nature of wireless channels. For example, external factors like interference, physical barriers, and fluctuating signal strengths can all impact retransmission success. These unpredictable conditions often lead to failures within the set retry limits. Thus, a better retransmission process is desired.

### SUMMARY

In an embodiment, robust retransmissions are performed at the medium access control layer for ultra-high reliability. In another example, a cross-link retransmission and ultra-high reliability (UHR) capability information element format between an access point multi-link device (AP MLD) and non-AP MLD is indicated.

In an embodiment, the traffic ID link mapping (TTLM) procedure is segregated for new transmissions and retransmissions.

In an embodiment, a traffic identifier (TID) mapping is provided for intra-AP MLD cross-link retransmission.

In an embodiment, TID mapping is provided for inter-AP MLD cross-link retransmission.

In an embodiment, a TTLM format for link mapping scheme for retransmissions for any or all TIDs is provided.

One aspect of the present disclosure provides a Retransmission Function (RTF) entity between the Upper medium access control (MAC) layer and Lower MAC layer to perform retransmission of data frames.

In an embodiment, an RTF header is included for the data frames that are desired for retransmission.

One aspect of the present disclosure provides a method for performing a link analysis for selecting a suitable link for retransmission of data frames.

One aspect of the present disclosure provides a non-Access Point Multi Link Device (non-AP MLD) in a wireless network. The non-AP MLD comprises at least one retransmission handler including processing circuitry. The non-AP MLD comprises memory storing instructions that, when executed by the at least one retransmission handler individually or collectively, cause the non-AP MLD to transmit, to an AP MLD, an indication of support for cross-link retransmissions. The memory storing instructions that, when executed by the at least one retransmission handler individually or collectively, cause the non-AP MLD to receive, from the AP MLD, control information to facilitate a cross-link retransmission, wherein the control information comprises all supported links for retransmissions. The memory storing instructions that, when executed by the at least one retransmission handler individually or collectively, cause the non-AP MLD to retransmit, to the AP MLD, data frames appended with a retransmission function (RTF) header over at least one supported link of all the supported links.

In some examples, the transmitting, to the AP MLD, data frames appended with a retransmission function (RTF) header over at least one supported link of all the supported links comprises receiving, from the AP MLD, an indication for retransmission link mapping of all the supported links for performing the retransmission, wherein the retransmission link mapping is indicated in a traffic identifier (TID)-to-link mapping (TTLM) control field. In some examples, the transmitting, to the AP MLD, data frames appended with a retransmission function (RTF) header over at least one supported link of all the supported links comprises determining the at least one supported link from all the supported links for performing the retransmission of the data frames based on monitoring a set of evaluation parameters of the at least one supported link during retransmission. In some examples, the transmitting, to the AP MLD, data frames appended with a retransmission function (RTF) header over at least one supported link of all the supported links comprises appending the RTF header for data frames that are intended for retransmission. In some examples, the transmitting, to the AP MLD, data frames appended with a retransmission function (RTF) header over at least one supported link of all the supported links comprises retransmitting, to the AP MLD, the data frames appended with RTF header over the determined at least one supported link.

In some examples, the set of link evaluation parameters of the at least one supported link comprises at least one of a radio link signal strength, a radio link signal quality, a radio link's Signal to Interference and Noise Ratio (SINR), channel attributes such as Channel Quality Indicator (CQI), link availability, or channel availability for transmission.

In some examples, the appending the RTF header for the data frames that are intended for retransmission comprises determining whether the cross-link retransmission is configured across inter-AP MLD links.

In some examples, the instructions, when executed by the at least one retransmission handler individually or collectively, cause the non-AP MLD to determine the cross-link retransmission is configured across the inter-AP MLD links. The instructions, when executed by the at least one retransmission handler individually or collectively, cause the non-AP MLD to append the RTF header that includes an AP MLD identification (ID), and a TID of the data frames for retransmission.

In some examples, the instructions, when executed by the at least one retransmission handler individually or collectively, cause the non-AP MLD to determine the cross-link retransmission is not configured across inter-AP MLD links. The instructions, when executed by the at least one retransmission handler individually or collectively, cause the non-AP MLD to append the RTF header that includes the TID of the data frames for retransmission.

One aspect of the present disclosure provides an Access Point Multi-Link Device (AP MLD) in a wireless communication network. The AP MLD comprises at least one retransmission handler including processing circuitry. The AP MLD comprises memory storing instructions that, when executed by the at least one retransmission handler individually or collectively, cause the AP MLD to transmit, to a non-AP MLD, a multi-link capability information element indicating support for cross-link retransmission. The memory storing instructions that, when executed by the at least one retransmission handler individually or collectively, cause the AP MLD to set a traffic identifier (TID) to-link mapping (TTLM) that maps a TID to all supported links for retransmissions of the AP MLD, wherein the TTLM is applicable for both an intra-AP MLD operation and an inter-AP MLD operation. The memory storing instructions that, when executed by the at least one retransmission handler individually or collectively, cause the AP MLD to transmit, to the non-AP MLD, control information to facilitate a cross-link retransmission, wherein the control information comprises all the supported links for retransmissions. In some examples, to transmit the multi-link capability information element, the instructions that, when executed by the at least one retransmission handler individually or collectively, cause the AP MLD to detect a support for a cross-link retransmission capability, wherein the cross-link retransmission capability applies to the intra-AP MLD operation and the inter-AP MLD operation. To transmit the multi-link capability information element, the instructions that, when executed by the at least one retransmission handler individually or collectively, cause the AP MLD to transmit the multi-link capability information element to the non-AP MLD indicating support for the cross-link retransmission.

In some examples, the instructions that, when executed by the at least one retransmission handler individually or collectively, further cause the AP MLD to segregate a TTLM configuration for a new transmission for the TID with the non-AP MLD and a TTLM configuration for retransmission for a TID associated with the non-AP MLD.

In some examples, to set the TTLM, the instructions that, when executed by the at least one retransmission handler individually or collectively, cause the AP MLD to determine whether the non-AP MLD supports an inter-AP MLD multi-connectivity and the cross-link retransmission. To set the TTLM, the instructions that, when executed by the at least one retransmission handler individually or collectively, cause the AP MLD to transmit, to a neighbor AP MLD, a cross-link retransmission request message to request to use supported radio links of the neighbor AP MLD for retransmission of data frames of the non-AP MLD, based at least in part on the non-AP MLD supporting the inter-AP multi-connectivity and the cross-link retransmission. To set the TTLM, the instructions that, when executed by the at least one retransmission handler individually or collectively, cause the AP MLD to receive a cross-link retransmission response message from the neighbor AP MLD providing an acceptance to use the supported radio links of the neighbor AP MLD for retransmission of the data frames of the non-AP MLD. To set the TTLM, the instructions that, when executed by the at least one retransmission handler individually or collectively, cause the AP MLD to perform a multi-link re-setup procedure with the non-AP MLD to configure all the supported radio links of the AP MLD and the neighbor AP MLD for performing the retransmissions of the data frames of the non-AP MLD. To set the TTLM, the instructions that, when executed by the at least one retransmission handler individually or collectively, cause the AP MLD to map the TID of data frames associated with the non-AP MLD to all supported radio links of the AP MLD and neighbor AP MLD for retransmission of the data frames in a TTLM configuration for the retransmission.

In some examples, the instructions that, when executed by the at least one retransmission handler individually or collectively, cause the AP MLD to receive a cross-link retransmission reject message from the neighbor AP MLD providing a rejection to use the supported radio links of the neighbor AP MLD for retransmission of the data frames of the non-AP MLD. The instructions that, when executed by the at least one retransmission handler individually or collectively, cause the AP MLD to refrain from performing the multi-link re-setup procedure with the non-AP MLD based at least in part on receiving the cross-link retransmission rejection message.

In some examples, to transmit the control information to facilitate cross-link retransmissions, the instructions that, when executed by the at least one retransmission handler individually or collectively, cause the AP MLD to determine whether support for the cross-link retransmissions is configured across inter-AP MLD links.

In some examples, the instructions that, when executed by the at least one retransmission handler individually or collectively, cause the AP MLD to determine that the cross-link retransmission is configured across the inter-AP MLD links. The instructions that, when executed by the at least one retransmission handler individually or collectively, cause the AP MLD to add a retransmission link mapping of the AP MLD, an AP MLD ID of the neighbor AP MLD, and a retransmission link mapping of radio links associated with the neighbor AP MLD in a TTLM control field of the control information.

In some examples, the instructions that, when executed by the at least one retransmission handler individually or collectively, cause the AP MLD to determine that the cross-link retransmission is not configured across the inter-AP MLD links. The instructions that, when executed by the at least one retransmission handler individually or collectively, cause the AP MLD to add a retransmission link mapping of the AP MLD in a TTLM control field of the control information.

One aspect of the present disclosure provides a method for managing data retransmission in a wireless network. The method comprises transmitting, by a non-access point (AP) multi-link device (MLD), an indication of support for cross-link retransmission to an AP MLD. The method comprises receiving, by the non-AP MLD, a control information from the AP MLD to facilitate a cross-link retransmission, wherein the control information comprises all supported links of the AP MLD for retransmissions. The method comprises retransmitting, by the non-AP MLD, data frames appended with a retransmission function (RTF) header over at least one supported link of all the supported links of the AP MLD.

In some examples, the retransmitting of the data frames appended with RTF header over at least one supported link to the AP MLD comprises receiving, by the non-AP MLD, an indication from the AP MLD for retransmission link mapping of all the supported links for performing the retransmission. The retransmission link mapping is indicated in a traffic identifier (TID)-to-link mapping (TTLM) control field. The retransmitting the data frames appended with RTF header over at least one supported link to the AP MLD comprises determining, by the non-AP MLD, the at least one supported link from all the supported links for performing the retransmission of the data frames based on monitoring a set of evaluation parameters of the at least one supported link during retransmission. The retransmitting of the data frames appended with RTF header over at least one supported link to the AP MLD comprises appending, by the non-AP MLD, the RTF header for data frames that are intended for retransmission. The retransmitting of the data frames appended with RTF header over at least one supported link to the AP MLD comprises retransmitting, by the non-AP MLD, the data frames appended with RTF header over the determined at least one supported link to the AP MLD

In some examples, the set of link evaluation parameters of the at least one supported link comprises at least one of a radio link signal strength, a radio link signal quality, a radio link's Signal to Interference and Noise Ratio (SINR), channel attributes such as Channel Quality Indicator (CQI), link availability, or channel availability for transmission.

In some examples. the appending the RTF header for the data frames that are intended for retransmission comprises determining, by the non-AP MLD, whether the cross-link retransmission is configured across inter-AP MLD links.

In some examples, the method comprises determining, by the non-AP MLD, the cross-link retransmission is configured across the inter-AP MLD links. In some examples, the method comprises appending, by the non-AP MLD, the RTF header that includes an AP MLD identification (ID), and a TID of the data frames for retransmission.

In some examples, the method comprises determining, by the non-AP MLD, the cross-link retransmission is not configured across inter-AP MLD links. In some examples, the method comprises appending, by the non-AP MLD, the RTF header that includes the TID of the data frames for retransmission.

These and other aspects of the disclosure will be better understood with the following description and accompanying drawings. The descriptions, while indicating embodiments and specific details, are for illustration and not limitation. Many changes and modifications can be made within the scope of the claims.

### BRIEF DESCRIPTION OF FIGURES

The features, aspects, and advantages of the present embodiments are illustrated in the accompanying drawings, where like reference letters indicate corresponding parts across various figures. The embodiments will be better understood from the following description with reference to the drawings.

FIG. 1A is a schematic diagram that illustrates the TTLM procedure in MLO according to an embodiment.

FIG. 1B is a schematic diagram that illustrates challenges that occur during retransmission of data frames according to an embodiment.

FIG. 1C is a schematic diagram that illustrates mapping TIDs of the data frames to a subset of links for performing transmission and retransmission according to an embodiment.

FIG. 2 is a block diagram of AP MLD for managing data retransmissions in a wireless communication network according to an embodiment.

FIG. 3 is a block diagram of non-AP MLD for managing data retransmissions in a wireless communication network according to an embodiment.

FIG. 4 is a schematic diagram that illustrates the process of handling intra-AP MLD cross-link retransmission and inter-AP MLD cross-link retransmission in the MAC layer according to an embodiment.

FIG. 5 is a flow diagram that illustrates a method for managing data retransmissions in a wireless communication network by AP MLD according to an embodiment.

FIG. 6 is a flow diagram that illustrates a method for managing data retransmissions in a wireless communication network by non-AP MLD according to an embodiment.

FIG. 7 is a schematic diagram that illustrates an indication of cross-link retransmission support between AP MLD and non-AP MLD according to an embodiment.

FIG. 8 is a schematic diagram that illustrates the TTLM procedure for intra-AP MLD cross-link retransmission according to an embodiment.

FIG. 9 is a schematic diagram that illustrates the TTLM procedure for inter-AP MLD cross-link retransmission according to an embodiment.

FIG. 10 is a sequence diagram that illustrates a signaling mechanism to configure inter-AP MLD cross-link retransmission according to an embodiment.

FIG. 11 is a schematic diagram that illustrates a TTLM format for link mapping for retransmission for all TIDs according to an embodiment.

FIG. 12 is a schematic diagram that illustrates an RTF entity in the protocol stack of MLD according to an embodiment.

FIG. 13 is a flow diagram that illustrates a method of performing a cross-link retransmission using an RTF entity according to an embodiment.

FIG. 14 is a schematic diagram that illustrates an RTF header included in data frames intended for retransmission according to an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION OF INVENTION

It may be noted that, to the extent possible, like reference numerals have been used to represent like elements in the drawing. Furthermore, those of ordinary skill in the art will appreciate that elements in the drawing are illustrated for simplicity and may not necessarily have been drawn to scale. For example, the dimensions of some of the elements in the drawing may be exaggerated relative to other elements to improve the understanding of aspects of the proposed invention. Further, the elements may have been represented in the drawing by conventional symbols, and the drawings may show only those specific details that are pertinent to understanding the embodiments of the proposed invention so as not to obscure the drawing with details that will be readily apparent to those of ordinary skill in the art having the benefit of the description herein.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with a plurality of other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not to be construed as limiting the scope of the embodiments herein.

As is traditional in the field, embodiments are described and illustrated in terms of blocks that carry out a described function or functions. These blocks, which are referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. The circuits, for example, may be embodied in one or more semiconductor chips or on substrate supports such as printed circuit boards and the like. The circuits constituting a block may be implemented by dedicated hardware or by a processor (e.g., one or more programmed microprocessors and associated circuitry) or by a combination of dedicated hardware to perform some functions of the block and a processor to perform other functions of the block. Each block of the embodiments may be physically separated into two or more interacting and discrete blocks without departing from the scope of the proposed method. Likewise, the blocks of the embodiments may be physically combined into more complex blocks without departing from the scope of the proposed method. The processor can include processing circuitry, which can be implemented by a circuit, for example a system on chip (SoC) or an integrated circuit (IC). The processor may include the combination of one or more processors such as a CPU, GPU, MPU, an application processor (AP), and a communication processor (CP).

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented with hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

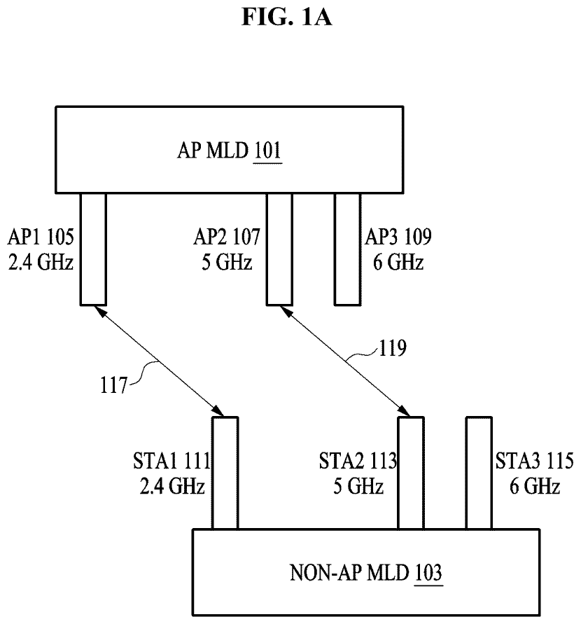

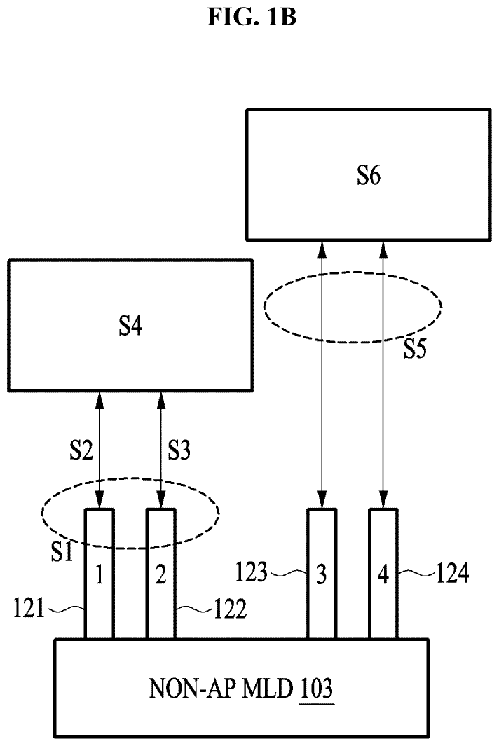

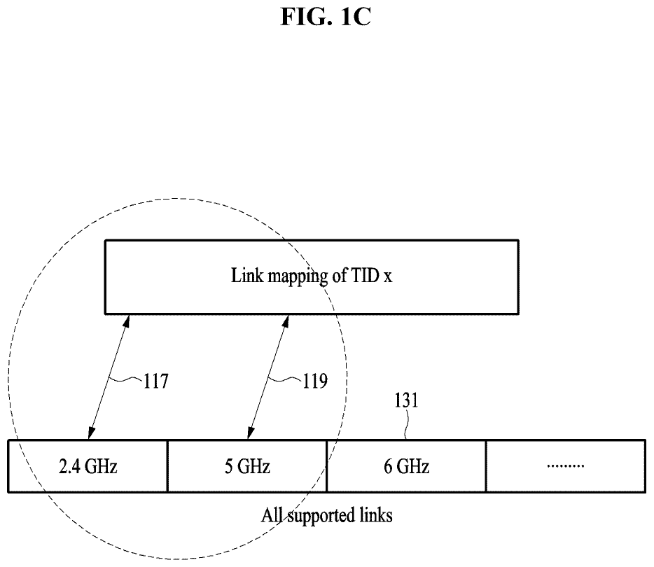

FIG. 1A is a schematic diagram illustrating the traffic identifier (TID) link mapping (TTLM) procedure in MLO according to an embodiment. In an embodiment, an AP MLD (101) performs data transmissions or retransmissions with a non-AP MLD (103). In an embodiment, AP MLD (101) supports three links or APs such as AP1 (105), AP2 (107), and AP3 (109). Each of the APs (e.g., AP1 (105), AP2 (107), and AP3 (109), is configured for a particular frequency channel. For example, AP1 (105) operates at a frequency of 2.4 GHz, AP2 (107) operates at a frequency of 5 GHz, and AP3 (109) operates at a frequency of 6 GHz. In an embodiment, the AP MLD (101) selects the channels with frequencies of 2.4 GHz and 5 GHz for performing data transmission with the non-AP MLD (103).

In an embodiment, the non-AP MLD (103) supports three links or stations (STAs) (e.g., interchangeably used as client devices), such as STA1 (111), STA2 (113), and STA3 (115). In an embodiment, each of the stations, STA1 (111), STA2 (113), and STA3 (115), is configured to operate at a separate frequency. For example, STA1 (111) operates at a frequency of 2.4 GHz, STA2 (113) operates at a frequency of 5 GHz, and STA3 (115) operates at a frequency of 6 GHz. In an embodiment, the AP MLD (101) transmits data frames to STA1 (111) and STA2 (113) associated with the non-AP MLD (103) through data links (117, 119) simultaneously connected to selected channels.

In an embodiment, the active links (117, 119) for data transmission or retransmission between the non-AP MLD (103) and the AP MLD (101) are restricted to one serving AP MLD (101). In an embodiment, application-specific data frames or QoS-specific data frames are associated with the TID, which is mapped to a subset of links (117, 119) using the TTLM procedure. In an embodiment, retransmission of the QoS-specific data frame or the application-specific data frame is performed at the MAC layer using per frame (e.g., using MAC protocol data unit (MPDU)) retransmission via Automatic Repeat Request (ARQ) through an acknowledgement (Ack) frame. Further, retransmission is performed using acknowledgment for an aggregated block of MPDUs (A-MPDU) via a Block Acknowledgement (BA) frame configured as per the BA agreement.

In an embodiment, when the BA agreement is not established, retransmissions are handled through an individually addressed data delivery mechanism. The existing technique retransmits downlink (DL) and uplink (UL) data frames corresponding to each TID through the mapped links. For example, the AP MLD (101) performs retransmission of data frames to the non-AP MLD (103) through the mapped links (117, 119). Conventional retransmission procedures have several limitations, such as retransmission buffer size limitations, data frame MPDU/A-MPDU lifetime limit expiration, retry count and retry limit reached, MAC discard, and the inability to perform a new transmission until retransmission is concluded with a success/failure result in the case of individually addressed frames when the BA agreement is not established for a TID.

FIG. 1B is a schematic diagram illustrating challenges that occur during the retransmission of data frames according to an embodiment. As shown in FIG. 1B, the non-AP MLD (103) supports four links for data transmission/retransmission.

At step S1, the TID corresponding to the data frames transmitted/retransmitted from non-AP MLD (103) is mapped to a subset link 1 (121) and a subset link 2 (122).

At step S2, subset link 1 (121) can be dynamically affected due to poor channel quality, causing the retransmission of the data frames to fail.

At step S3, subset link 2 (122) can move to a doze state, pausing or failing the retransmission of the data frames.

Accordingly, during step S4, the non-AP MLD (103) attempts to retransmit/transmit the data frames on subset link 1 (121) and subset link 2 (122) until the maximum number of attempts is reached. If the maximum number of retransmission attempts is exceeded, the retransmission of the data frames fails, and the frames are lost.

At steps S5 and S6, while the retransmission of the frames fails on subset link 1 (121) and subset link 2 (122), subset link 3 (123) and subset link 4 (124), are not used. That is, subset link 3 (123) and subset link 4 (124) associated with the non-AP MLD (103) are not considered for retransmission. In an embodiment, the subset link 3 (123) and subset link 4 (124) have a better channel condition than subset link 1 (121) and subset link 2 (122). That is, despite subset link 3 (123) and subset link 4 (124) having better channel conditions than subset link 1 (121) and subset link 2 (122), they are not considered.

In an embodiment, the robustness of a quality of service (QoS) data frame retransmission mechanism helps achieve true and practical UHR Key Performance Indicators (KPIs)—e.g., providing the system with low latency and high reliability. However, conventional retransmission procedures at the MAC layer include several limitations, such as: a retransmission buffer size limit (e.g., where a large number of retransmission can cause buffer overflow and frame drops), a data frame lifetime limit expiration (e.g., where the frame is discarded after the lifetime limit expires), a successful delivery of data frames can occur only within a limited retry count (e.g., irrespective of a weak/poor channel scenario, reducing a probability of success), a framework limitation of waiting for retransmission to conclude before starting new transmission in non-BA agreement scenarios for individually addressed frames, retransmission are limited to a configured subset of links mapped to TID (e.g., limited to subset link 1 and subset link 2), retransmission may be hampered if the corresponding link has moved to a lower power state or doze state, and/or during retransmission, the channel can be dynamically affected by external factors (e.g., channel congestion, weak signal strength/quality, interference, etc.), further reducing a chance of a successful retransmission within the limits.

Thus, there is a desire to handle the retransmission procedure at the MAC layer and utilize the subset links for retransmission.

FIG. 1C is a schematic diagram illustrating the mapping of TIDs of data frames to a subset of links for performing transmissions and retransmissions according to an embodiment. This figure represents a conventional solution TTLM configuration where each TID of the data frame is mapped to only a subset of active links (117, 119) for performing transmissions or retransmissions. Some subset links (131) are not mapped to TIDs. This conventional solution may lead to inefficient utilization of links for retransmission.

As described herein, robust retransmission occurs at a MAC layer efficiently to support UHR goals for high-priority, low-latency data transmissions. In an embodiment, the TTLM framework is enhanced by mapping all supported links for a TID retransmission. Further, the retransmission function (RTF), performed by the RTF entity, conducts real-time evaluation for all the links mapped for retransmission. As a result of this real-time evaluation, the most suitable link is selected among all the links to perform the retransmission, thereby maximizing the retransmission success possibility. In an embodiment, cross-link retransmission is performed for both intra-AP MLD and inter-AP MLD links.

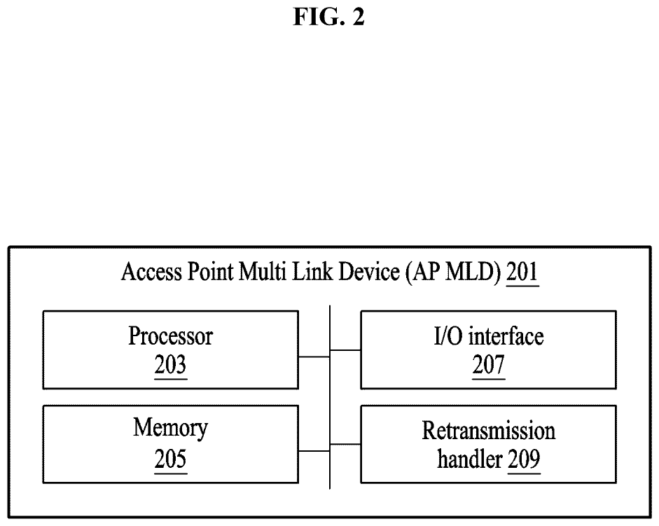

FIG. 2 is a block diagram of an access point (AP) multi-link device (MLD) (201) for handling robust retransmissions at a medium access control (MAC) layer, according to an embodiment. The AP MLD (201) is an example of an access point device. In an embodiment, AP MLD (201) includes a processor (203), a memory (205), an I/O interface (207), and a retransmission handler (209). In an embodiment, the processor (203) of the AP MLD (201) communicates with the memory (205), the I/O interface (207), and the retransmission handler (209). The processor (203) can include processing circuitry, which can be implemented by a circuit, for example a system on chip (SoC) or an integrated circuit (IC).

In an embodiment, processor (203) is configured to execute instructions stored in the memory (205) and to perform various processes. The processor (203) can include one or a plurality of processors and/or processing circuitry. In an embodiment, the processor (203) can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

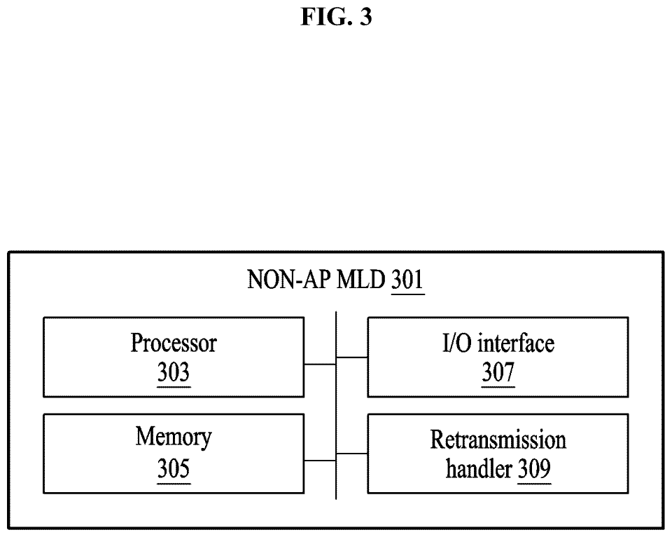

Furthermore, the memory (205) of the AP MLD (201) includes storage locations that can be addressed through the processor (203). The memory (205) stores instructions that, when executed by at least one processor (203) and/or at least one a retransmission handler (209) individually or collectively, cause the AP MLD (201) to perform the methods and/or the operations described herein. In an embodiment, the memory (205) is not limited to volatile or non-volatile memory and can include one or more computer-readable storage media. For example, memory (205) can include non-volatile storage elements such as magnetic hard disks, optical discs, floppy discs, flash memories, EPROM, or EEPROM memories. In an embodiment, the memory (205) of the AP MLD (201) can store various information received from a non-AP MLD (e.g., non-AP MLD (103) or non-AP MLD (301) as described with reference to FIGS. 1 and 3, respectively). In an embodiment, the AP MLD (201) stores the one or more information such as associated client's authentication and association information, capability information, present MAC and physical layer (PHY) configurations and present data session context.

In an embodiment, I/O interface (207) transmits information between the memory (205) and external peripheral devices, which are input-output devices associated with the AP MLD (201). The I/O interface (207) receives various information from the non-AP MLD. This information can include, but is not limited to, capability information, data traffic identifier (TID) and security context, control and configuration (e.g., such as link configuration) related signaling of the associated non-AP MLDs.

In an embodiment, retransmission handler (209) communicates with the I/O interface (207) and memory (205) for handling robust retransmissions at MAC layer. In an embodiment, retransmission handler (209) is hardware that is realized through the physical implementation of both analog and digital circuits, including logic gates, integrated circuits, microprocessors, microcontrollers, memory circuits, passive and active electronic components, as well as optical components. The retransmission handler (209) can include processing circuitry, which can be implemented by a circuit, for example a system on chip (SoC) or an integrated circuit (IC). The retransmission handler (209) may include the combination of one or more processors such as a CPU, GPU, MPU, an application processor (AP), and a communication processor (CP). In an embodiment, the retransmission handler (209) may be implemented by and/or included in the processor (203). In an embodiment, retransmission handler (209) transmits the UHR multi-link capability information element to the non-AP MLD, indicating support for cross-link retransmission. In some examples, the retransmission handler (209) also maps TID to all supported links for retransmissions within the AP MLD (201). In an embodiment, TID-to-link mapping (TTLM) is applicable for both intra-AP MLD and inter-AP MLD scenarios. Furthermore, the retransmission handler (209) transmits the control information to the non-AP MLD to facilitate the cross-link retransmission. In an embodiment, the control information includes all the supported links.

In an embodiment, the retransmission handler (209) detects the support for the cross-link retransmission feature capability. In an embodiment, the AP MLD cross-link retransmission feature applies to the intra-access point (AP) MLD and the inter-AP MLD scenarios. Further, the retransmission handler (209) transmits the UHR multi-link capability information element to the non-AP MLD indicating support for cross-link retransmission.

In an embodiment, the retransmission handler (209) segregates the TTLM configuration for new transmissions for the TID with the non-AP MLD and the TTLM configuration for retransmissions for a TID associated with the non-AP MLD. In an embodiment, the segregation ensures that the retransmission handler (209) can handle new transmissions and retransmissions independently while also optimizing the network usage. By maintaining separate configurations, the retransmission handler (209) can dynamically adjust to varying requirements of new data frames and those requiring retransmission, thereby enhancing overall network performance. In an embodiment, to map the TID to all supported links for retransmission, the retransmission handler (209) determines whether the non-AP MLD supports inter-AP MLD multi-connectivity and cross-link retransmission. In an embodiment, the retransmission handler (209) determines the non-AP MLD supports inter-AP multi-connectivity and cross-link retransmission. In an embodiment, the retransmission handler (209) transmits a Cross-Link Retransmission Request message to a neighboring AP MLD requesting a use of supported radio links of the neighboring AP MLD for retransmission of the data frames of the non-AP MLD. In an embodiment, upon receiving the Cross-Link Retransmission Response message from the neighboring AP MLD, the retransmission handler (209) proceeds based on the acceptance to use the supported radio links of the neighboring AP MLD for retransmission of the data frames of the non-AP MLD. In some examples, the retransmission handler (209) can receive a Cross-Link Retransmission Rejection. In such examples, the retransmission handler (209) can refrain from using the supported radio links of the neighboring AP MLD for retransmission of the data frames of the non-AP MLD. In an embodiment, the retransmission handler (209) receives the response message, the retransmission handler (209) then performs the multi-link re-setup procedure with the non-AP MLD to configure all supported radio links of the AP MLD and neighboring AP MLD for retransmissions of the data frames of the non-AP MLD. In an embodiment, the retransmission handler (209) further maps the TID of data frames associated with the non-AP MLD to all supported radio links of the AP MLD and neighboring AP MLD for retransmission in the TTLM configuration.

To facilitate cross-link retransmissions based on the cross-link retransmission feature capability and the TID-to-link mapping, the retransmission handler (209) determines whether a cross-link retransmission is configured across inter-AP MLD links. When the cross-link retransmission is configured across inter-AP MLD links, the retransmission handler (209) adds the retransmission link mapping of the AP MLD (201), the AP MLD ID of the neighboring AP MLD, and the retransmission link mapping of the radio links associated with the neighboring AP MLD in the TTLM control field. If the cross-link retransmission is not configured across inter-AP MLD links, the retransmission handler (209) adds only the retransmission link mapping of the AP MLD in the TTLM control field. This selective mapping ensures that the network efficiently utilizes available resources, maintaining high performance while minimizing unnecessary overhead.

FIG. 3 is a block diagram of a non-AP MLD (301) for managing data transmissions and retransmissions in a wireless communication network, according to an embodiment. In an embodiment, the non-AP MLD (301) can be, but not limited to client devices such as a user equipment (UE), desktop, and the like. In an embodiment, the non-AP MLD (301) includes a processor (303), a memory (305), an I/O interface (307), and retransmission handler (309). Furthermore, the processor (303) of the non-AP MLD (301) communicates with the memory (305), the I/O interface (307), and the retransmission handler (309). In an embodiment, processor (303) is configured to execute instructions stored in the memory (305) and to perform various processes. The processor (303) can include processing circuitry, which can be implemented by a circuit, for example a system on chip (SoC) or an integrated circuit (IC). In an embodiment, processor (303) can include one or a plurality of processors. The processor (303) can be an example of a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

Furthermore, the memory (305) of the non-AP MLD (301) includes storage locations that can be addressed through the processor (303). The memory (305) stores instructions that, when executed by at least one processor (303) and/or at least one a retransmission handler (309) individually or collectively, cause the non-AP MLD (301) to perform the methods and/or the operations described herein. In an embodiment, the memory (305) is not limited to volatile or non-volatile memory. For example, memory (305) can include one or more computer-readable storage media, non-volatile storage elements such as magnetic hard disks, optical discs, floppy discs, flash memories, EPROM, or EEPROM memories can also be included in the memory (305). Further, the memory (305) of the non-AP MLD (301) can store various information received from the AP MLD (201). The non-AP MLD (301) stores the one or more information. In an embodiment, the information can include the indication of support for cross-link retransmission provided by the AP MLD (201), authentication, association and security related parameters, link configuration, data session context, TTLM procedure configuration, TIDs mapped for all links for retransmission and the like.

In an embodiment, the I/O interface (307) transmits information between the memory (305) and external peripheral devices (e.g., not illustrated), which are input-output devices associated with the non-AP MLD (301). The I/O interface (307) receives various information from the AP MLD (201). This information can include, but is not limited to, indication of support for cross-link retransmission provided by the AP MLD (201), TIDs mapped for all links for retransmission and the like.

In an embodiment, retransmission handler (309) communicates with the I/O interface (307) and memory (305) for robust retransmission at a medium access control (MAC) layer. The Retransmission handler (309) is an innovative hardware that is realized through the physical implementation of both analog and digital circuits, including logic gates, integrated circuits, microprocessors, microcontrollers, memory circuits, passive and active electronic components, as well as optical components. The retransmission handler (309) can include processing circuitry, which can be implemented by a circuit, for example a system on chip (SoC) or an integrated circuit (IC). The retransmission handler (309) may include the combination of one or more processors such as a CPU, GPU, MPU, an application processor (AP), and a communication processor (CP). In an embodiment, the retransmission handler (309) may be implemented by and/or included in the processor (303).

In an embodiment, the retransmission handler (309) of the non-AP MLD (301) transmits an indication of support for cross-link retransmission to the AP MLD (201). Further, the retransmission handler (309) receives control information from an AP MLD (201) to facilitate a cross-link retransmission. In an embodiment, the control information includes all the supported links for the retransmissions. In an embodiment, the retransmission handler (309) retransmits/transmits the data frames appended with retransmission function (RTF) header in at least one supported link to the AP MLD (201).

In an embodiment, the retransmission handler (309) receives the indication from the AP MLD (201) for retransmission link mapping of all the supported links for performing the retransmission. In an embodiment, the retransmission link mapping is indicated in a TTLM control field. Further, the retransmission handler (309) determines at least one link from all the links that is suitable for performing the retransmission of data frames based on a set of evaluation parameters of the link during retransmission. In an embodiment, the retransmission handler (309) also appends the RTF header to data frames intended for retransmission. Subsequently, the retransmission handler (309) retransmits/transmits the data frames appended with the RTF header over the at least one determined link to the AP MLD (201).

In an embodiment, the set of link evaluation parameters includes radio link signal strength, radio link signal quality, a radio link's Signal to Interference and Noise Ratio (SINR), channel attributes such as Channel Quality Indicator (CQI), link availability, and channel availability for transmission. In an embodiment, using these parameters ensures that the selected link is optimal for retransmission, thereby reducing data frame loss and facilitating communication between the non-AP MLD (301) and the AP MLD (201). In an embodiment, the retransmission handler (309) continuously monitors these parameters to dynamically select the most suitable link for retransmission.

In an embodiment, to append the RTF header to the data frames, the retransmission handler (309) determines whether the cross-link retransmission is configured across inter-AP MLD links. In an embodiment, the retransmission handler (309) appends the RTF header that includes an AP MLD (201) ID and a TID of the data frames for retransmission. In an embodiment, when the cross-link retransmission is not configured across inter-AP MLD links, the retransmission handler (309) appends the RTF header that includes the TID of the data frames for retransmission. In an embodiment, the differentiation in header configuration ensures that the data frames are correctly identified and processed during retransmission.

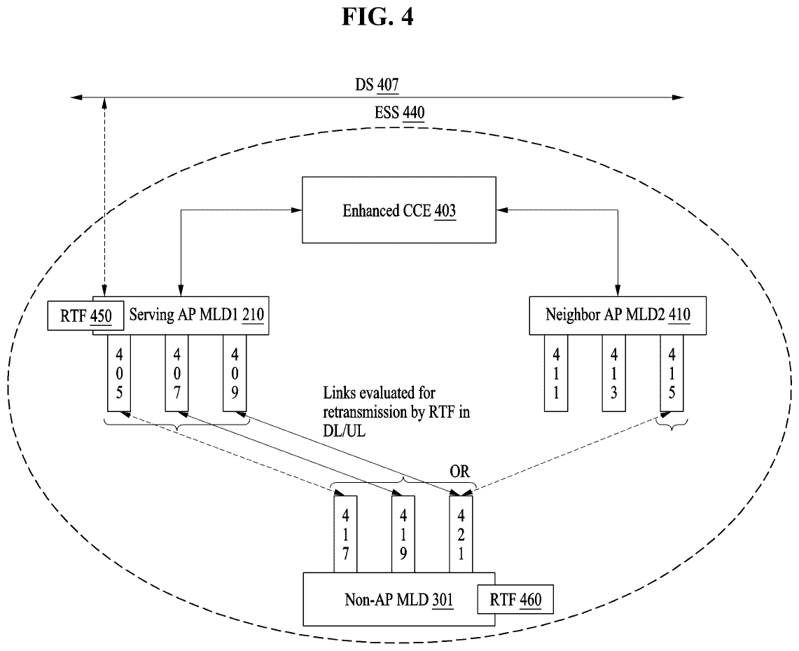

FIG. 4 is a schematic diagram that illustrates a process of handling intra-AP MLD cross link retransmission and inter-AP MLD cross link retransmission in an MAC layer, according to an embodiment. As shown in FIG. 4, a multi-link operation (MLO) is performed between a non-AP MLD (301), a serving AP MLD1 (210) and a neighbor AP MLD2 (410). In an embodiment, the neighbor AP MLD2 (410) can be an example of an AP MLD (201) as described with reference to FIG. 2. In an embodiment, serving AP MLD1 (210) and the neighbor AP MLD2 (410) are affiliated with a same Extended Service Set (ESS) (440). The serving AP MLD1 (210) and the neighbor AP MLD2 (410) are connected to an enhanced Common Control Entity (CCE) (403). In an embodiment, the serving AP MLD1 (210) and the non-AP MLD (301) includes a retransmission function (RTF) entity (460) for handling and performing the retransmission of data frames. In an embodiment, non-AP MLD (301) indicates the support for cross-link retransmission capability with the serving AP MLD1 (210). Similarly, the serving AP MLD (210) indicates the support for cross-link retransmission capability with the non-AP MLD (301).

In an embodiment, upon the indication of cross-link retransmission, the serving AP MLD (210) maps the Traffic Identifier (TID) of the data frames intended for retransmission to all links (405, 407, 409) associated with the serving AP MLD (210) during intra-AP retransmission. Accordingly, during the inter-AP retransmission the serving AP MLD (210) maps the TID of the data frames intended for retransmission with (405, 407, 415). In an embodiment, the serving AP MLD (210) also determines the presence of neighbor AP MLD2 (410). In an embodiment, after determining the presence of the neighbor AP MLD2 (410), the serving AP MLD (210) configures at least one link associated with the neighbor AP MLD2 (410) for retransmission of data frames—e.g., the serving AP MLD (210) configures at least one of the links (411, 413, 415). In an embodiment, the serving AP MLD (210) configures at least the link (415). For example, the serving AP MLD (210) maps the TIDs of the data frames intended for retransmission to at least one link (415) associated with the neighbor AP MLD2 (410). In an embodiment, after mapping the TIDs to at least one link (415), serving AP MLD (210) transmits control information including a TTLM control field indicating the mapping of all TIDs for the retransmission of the data frames. For example, the control field includes an indication of mapping TIDs intended for retransmission to all links associated with serving AP MLD (210) and an indication of whether inter-AP MLD retransmission is available to utilize. In an embodiment, the control field also includes the AP MLD ID of the neighboring AP MLD2 (410), the mapping of TIDs to at least one configured link (415) associated with the neighboring AP MLD2 (410), and when the inter-AP MLD retransmission is available.

In an embodiment, the non-AP MLD (301) receives the control information from the serving AP MLD (210). Further, the RTF entity (460) associated with the non-AP MLD (301) determines the at least one link among all the configured links for the retransmission of the data frames. In an embodiment, RTF entity (460) determines the suitable link for the retransmission using the proposed link analysis. Upon determination, the non-AP MLD (301) appends the RTF header for the data frames intended for retransmission. In an embodiment, the RTF header includes the AP MLD ID and the TID of the data frames—e.g., the RTF header includes the AP MLD ID if retransmission across links in an inter-AP MLD retransmission operation is available. Further, the non-AP MLD (301) transmits the data frames intended for retransmission through the determined suitable links.

As described herein, an enhanced TTLM framework maps all the supported links (405, 407, 409) for TIDs for retransmission. In an embodiment, the RTF entity (450) performs real-time evaluation for all the links mapped for retransmission. In an embodiment, the RTF entity (450) further determines the best link for performing the retransmission, thereby maximizing successful retransmission. In an embodiment, the TTLM framework described herein supports both inter-AP MLD and intra-AP MLD. By utilizing the full MLO potential at the MAC layer as described herein, a robust retransmissions framework to support UHR goals for high-priority and low-latency data transmissions is achieved.

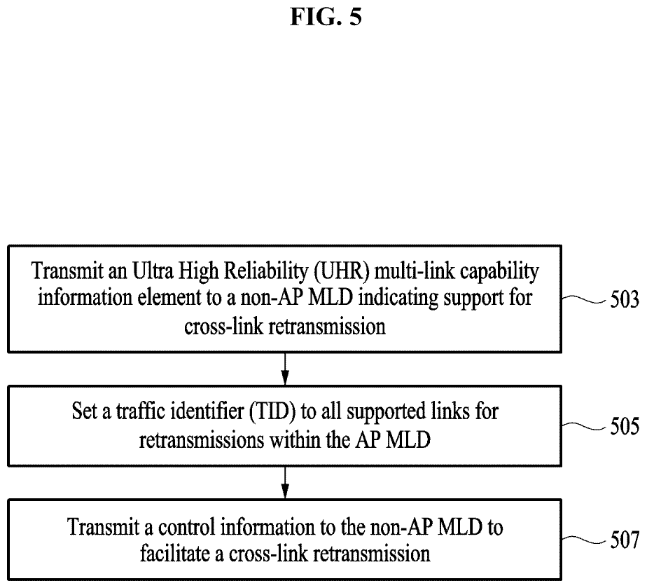

FIG. 5 is a flow diagram that illustrates a method for managing data retransmissions in a wireless communication network according to an embodiment. Although one or more operations are described or shown in particular sequential order, in some examples the operations may be rearranged in a different order, which may include performance of multiple operations in at least partially overlapping time periods.

At operation 501, the method includes transmitting the UHR multi-link capability information element to the non-AP MLD (301) indicating support for cross-link retransmission. In an embodiment, the AP MLD (201) transmits the UHR multi-link capability element. In an embodiment, the method includes transmitting a multi-link capability information element to the non-AP MLD (301).

Further, at operation 503, the method includes setting the TID to-link mapping (TTLM) that maps a TID to all supported links for retransmissions within the AP MLD (201). In an embodiment, the TTLM is applicable for both the intra-AP MLD and the inter-AP MLD scenarios.

At operation 505, the method includes transmitting the control information to the non-AP MLD (301) to facilitate the cross-link retransmission. In an embodiment, the control information includes all the supports links for retransmissions. In an embodiment, the control information can include an indication of mapping TID, an indication whether inter-AP MLD retransmission is available, and/or an AP MLD ID of a neighboring AP MLD. In an embodiment, the control information is transmitted by the AP MLD (201) to the non-AP MLD (301).

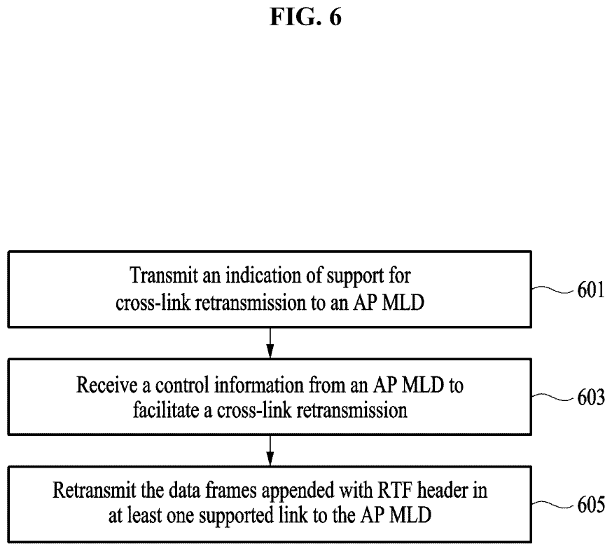

FIG. 6 is a flow diagram that illustrates a method for managing data retransmissions in a wireless communication network according to an embodiment. Although one or more operations are described or shown in particular sequential order, in some examples the operations may be rearranged in a different order, which may include performance of multiple operations in at least partially overlapping time periods.

At operation 601, the method includes transmitting the indication of support for cross-link retransmission to the AP MLD (201). In an embodiment, a non-AP MLD (301) transmits the indication of support to the AP MLD (201).

At operation 603, the method includes receiving the control information from an AP MLD (201) to facilitate a cross-link retransmission. In an embodiment, the control information includes all the supported links for retransmissions. In an embodiment, the control information is received at the non-AP MLD (301).

At operation 605, the method includes, retransmitting/transmitting the data frames appended with RTF header in the supported link to the AP MLD (201). In an embodiment, the non-AP MLD (301) retransmits/transmits the data frames appended with the RTF header.

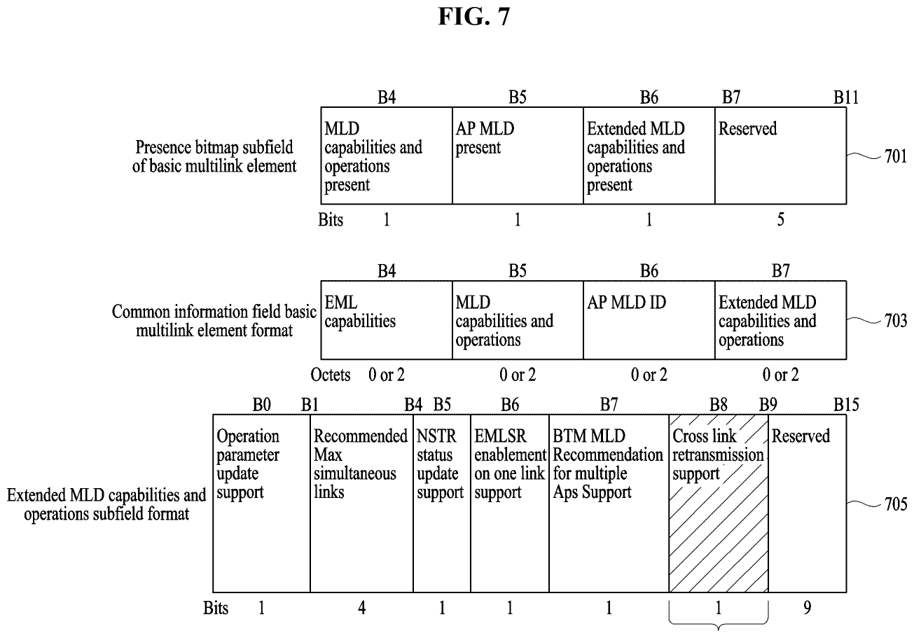

FIG. 7 is a schematic diagram illustrating an indication of cross-link retransmission support between an AP MLD (201) and a non-AP MLD (301) according to an embodiment.

In an embodiment, block 701 represents the presence bitmap subfield of a basic multilink element. In an embodiment, bit B6 of block 701 is reserved for extended MLD capabilities and operations presence.

Further, block 703 represents the common information field of the basic multilink element format, where bit B7 of block 703 is for indicating whether extended MLD capabilities and operations are present.

Block 705 represents the extended MLD capabilities and operations subfield format. In an embodiment, when bit B6 of block 701 indicates the extended MLD capabilities and operations are present and bit B7 of block 703 is present, then the extended MLD capabilities and operations subfield format and support for cross-link retransmission is indicated by bit B8 or a later reserved field within block 705.

In an embodiment, when bit B8 of block 705 is set to one ‘1’ or TRUE, it indicates that the cross-link retransmission capability is supported. In an embodiment, when bit B8 of block 705 is set to zero ‘0’ or FALSE, it indicates that the cross-link retransmission capability is not supported. In an embodiment, the AP MLD (201) and non-AP MLD (301) can provide the indication for the support of cross-link retransmission.

In an embodiment, bit B8 or a later reserved field from the Extended MLD Capabilities and Operations subfield format (e.g., block 705) is used to indicate the support for the cross-link retransmission feature. For example, when bit B8 is set to ‘1’ or TRUE and the AP MLD (201) and non-AP MLD (301) support the inter-AP MLD multi-connectivity feature, the cross-link retransmission feature can be supported for the links across the inter-AP MLD. In some examples, if bit B8 of block 705 is set to ‘1’ or TRUE and the AP MLD (201) and non-AP MLD (301) does not support the inter-AP MLD multi-connectivity feature, then the cross-link retransmission feature is not supported for the links across the inter-AP MLD.

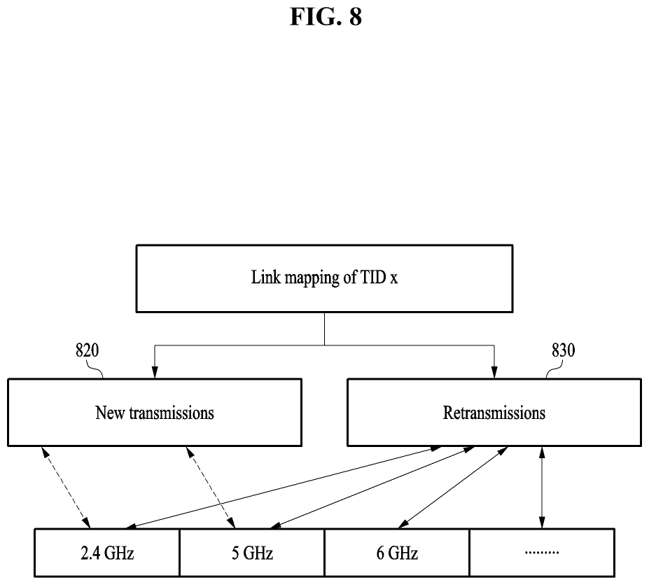

FIG. 8 is a schematic diagram that illustrates a Traffic ID to Link Mapping (TTLM) procedure for intra-AP MLD cross-link retransmission according to an embodiment. In an embodiment, FIG. 8 illustrates a robust framework for MAC layer data frame retransmissions. In an embodiment, the proposed TTLM procedure, the mapping of the TIDs to the links is segregated for the transmission of data frames and retransmission of data frames. In an embodiment, mapping of TIDs to link configuration for the transmission of data frames is segregated from the mapping of TIDs to link configuration for the retransmission of data frames.

In an embodiment, at block 820, TID to link mapping is for new transmissions, which are configured by including mapping with only a subset of active links. At block 830, TID to link mapping is for retransmissions, ensuring that the TID is mapped to all supported links for retransmissions at all times. In an embodiment, the mapping of TIDs to link configuration for the retransmission is performed by mapping all the TIDs of the data frames intended for retransmission to all the links. For example, all the links of 2.4 GHz, 5 GHz, and 6 GHz are mapped for the TIDs of the data frames intended for retransmission.

In an embodiment, during the intra-AP, timing for all links is synchronized efficiently during retransmissions so that retransmission frames from any link are received at the other end within an expected time frame.

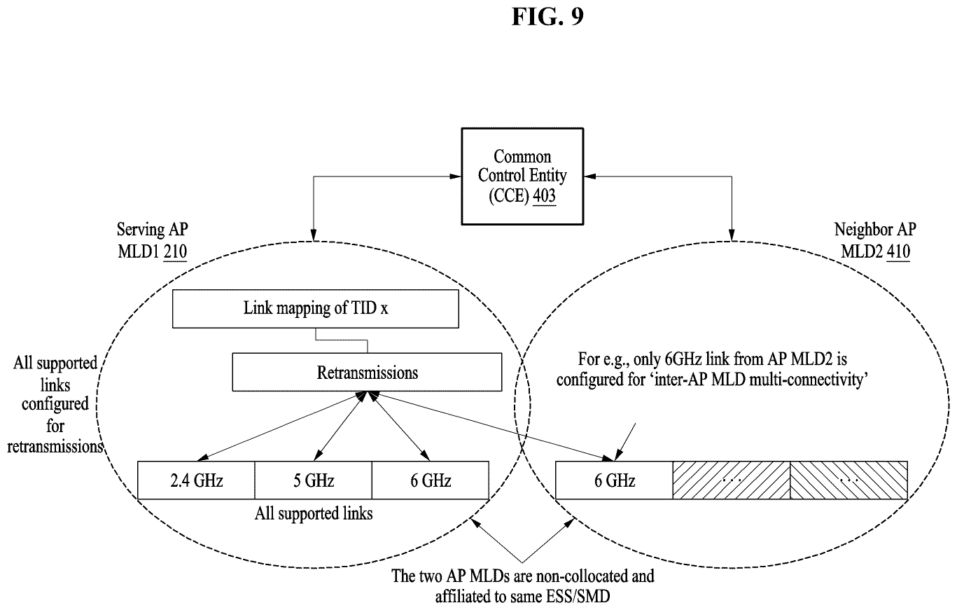

FIG. 9 is a schematic diagram that illustrates a Traffic ID to Link Mapping (TTLM) procedure for inter-AP MLD cross link retransmission, according to an embodiment.

In an embodiment, two non-collocated neighbor AP MLDs are present and affiliated to same Extended Service Set (ESS) or Seamless Mobility Domain (SMD). For example, AP MLD1 (201) and AP MLD2 (410) can be affiliated to the same ESS or SMD. In an embodiment, the non-AP MLD (301) (not illustrated) is operating in the inter-AP MLD multi-connectivity mode, where the non-AP MLD (301) is connected to the serving AP MLD1 (210) and the neighbor AP MLD 2 (410). In an embodiment, data forwarding and the data aggregation of the serving AP MLD1 (210) and the neighbor AP MLD 2 (410) takes place through the Common Control Entity (CCE) (403). In an embodiment, the serving AP MLD1 (210) provides the Link Mapping for the TIDs. That is, the serving AP MLD1 (210) maps the TIDs intended for retransmission to all the supported links or active links of the serving AP MLD1 (210) and the configured links of AP MLD2 (410). For example, as shown in FIG. 9, the serving AP MLD1 (210) maps the TIDs intended for retransmission to all the supported links or active links having frequency of 2.4 GHz, 5 GHz and 6 GHz of the serving AP MLD1 (210) and configured link of 6 GHz from AP MLD2 (410). That is, in an embodiment, the 6 GHz link of AP MLD2 (410) is the only link of AP MLD2 (410) configured for (e.g., capable of) inter-AP MLD multi-connectivity.

In an embodiment, the serving AP MLD (210) utilizes a TSF (Timing Synchronization Function) information by reading the neighbor AP MLD's (410) broadcasted Beacon frame for synchronizing timings for the inter-AP MLD links. Thus, the retransmissions can take place across inter-AP MLD and also the inter-AP MLD links when timing is synchronized efficiently for the retransmitted frames to reach the common MAC buffer for aggregation from both AP MLDs at an expected time.

In an embodiment, the inter-AP MLD scenario can be extended to a setup with serving AP MLD (links) and its associated range extender device (links) as well.

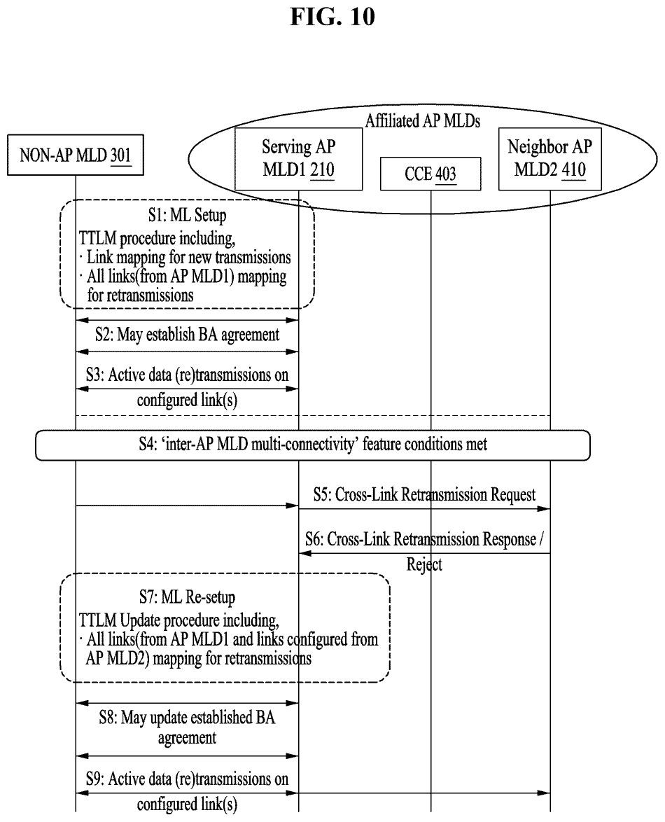

FIG. 10 is a sequence diagram that illustrates a signaling mechanism to configure inter-AP MLD cross link retransmission, according to an embodiment. Although one or more operations are described or shown in particular sequential order, in some examples the operations may be rearranged in a different order, which may include performance of multiple operations in at least partially overlapping time periods.

At step S1, the non-AP MLD (301) is associated (at an MLD level) to the serving AP MLD1 (210) with the TID-to-Link mapping configured (via ML Setup procedure) and with segregated mapping for new transmissions and retransmissions as described with reference to FIG. 8. In an embodiment, during step S1, all link from the AP MLD1 (201) are mapped for retransmissions.

At step S2, a Block Acknowledgement (BA) agreement can be established between the non-AP MLD (301) and the AP MLD1 (201).

At step S3, the active new data transmissions are ongoing over configured subset of supported links while active data retransmissions are ongoing over configured set of all supported links across AP MLD1 (201)—e.g., new data is being transmitted on the subset of supported links while data retransmission are ongoing over the setoff all supported links.

Further, at step S4, inter-AP MLD multi-connectivity' feature conditions are met and are configured between the non-AP MLD (301) and the serving AP MLD1 (210) and the neighbor AP MLD2 (410).

At step S5, the serving AP MLD1 (210) (e.g., either initiated by the AP MLD1 (201) or initiated by non-AP MLD (301) and forwarded by serving AP MLD1 (210)) sends a Cross-Link Retransmission Request to neighbor AP MLD2 (410). In an embodiment, the Cross-Link Retransmission Request includes the links (410) of AP MLD2's determined (e.g., configured for cross-link retransmissions) in step S4. In some examples, the AP MLD1 (201) seeks permission to use those links for independent retransmissions as well.

At step S6, the neighbor AP MLD2 (410) sends a Cross-Link Retransmission Response. In an embodiment, the neighbor AP MLD2 (410) provides an agreement that AP MLD (201) can use all or a subset of its link(s) as requested in step S5. In some examples, the AP MLD2 (410) can reject the request by transmitting a Cross-Link Retransmission Reject. In some examples, the AP MLD2 (410) denies usage of the configured AP MLD2's (410) link(s) for independent retransmissions. In an embodiment, the AP MLD2 (410) can transmit the Cross-Link Retransmission Reject message at a later stage—e.g., the AP MLD2 (410) can subsequently deny a request even if such request is accepted now. For example, the AP MLD2 can respond with a Cross-Link Retransmission Response at a first time and respond with a Cross-Link Retransmission Reject at a second time to deny usage of its configured link(s) for independent retransmissions due to load conditions, etc., on a per transmit opportunity (TXOP) basis during the second time.

In an embodiment, at step S7, TID-to-Link mapping is updated (e.g., via a multi-link (ML) re-setup procedure) such that at least all the supported links (across AP MLD1 (201)) and agreed links (across AP MLD2 (410)) are re-mapped for data retransmissions for the non-AP MLD (301).

At step S8, an established Block Acknowledgement (BA) agreement is updated.

At step S9, the active new data transmissions are ongoing over the configured subset of supported links (which may be configured across AP MLD1 (201) and AP MLD2 (410)). In an embodiment, active data retransmissions are ongoing over the configured set of all the supported links across AP MLD1 (201) and all agreed links across AP MLD2 (410).

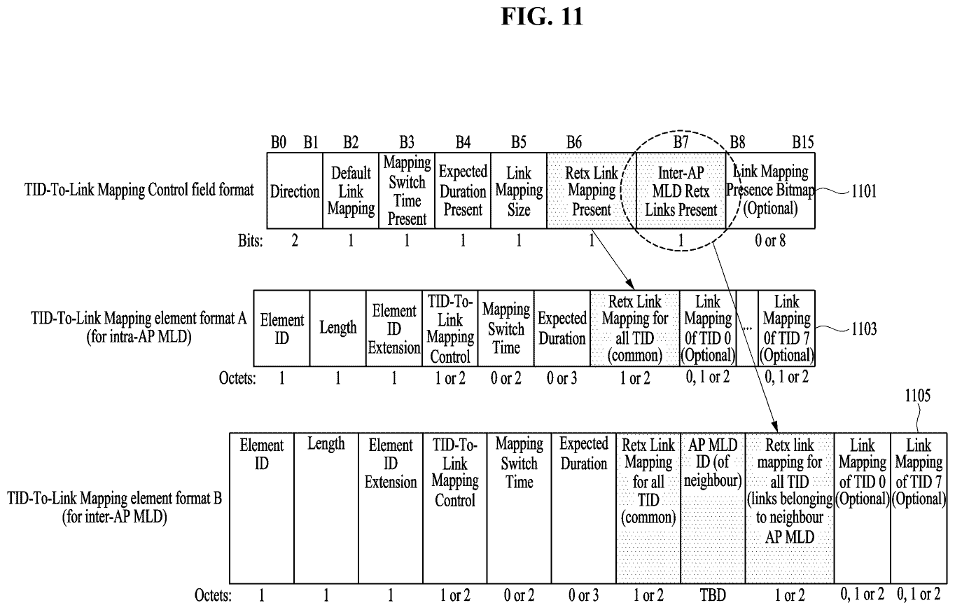

FIG. 11 is a schematic diagram illustrating a Traffic ID to Link Mapping (TTLM) format for link mapping for retransmission for all TIDs according to an embodiment. As shown in FIG. 11, the TID to link mapping for new transmission configuration uses the same parameters for all transmissions. In an embodiment, for retransmissions, the reserved bit B6 of the TTLM Control field (1103) is used to indicate the presence of Link Mapping (with all supported links) for retransmissions of any and all TIDs, whether present or not. In an embodiment, when the bit B6 has a value one ‘1,’ the link mapping for retransmissions of any and all TIDs is present. In an embodiment, when the bit B6 has a value zero ‘0,’ the link mapping for retransmissions of any and all TIDs is not present.

In an embodiment, when bit B6 is true (e.g., has a value ‘1’), the reserved bit B7 is used to indicate whether the link mapping for retransmissions involves intra-AP MLD (serving) links or involves inter-AP MLD neighbor links via the inter-AP MLD multi-connectivity feature, where the bit B7 having a value one ‘1’ means links across inter-AP MLD are present for mapping.

In an embodiment, when bit B6 is true (e.g., has a value ‘1’) and bit B7 is false (e.g., has a value ‘0’) (indicating links present across intra-AP MLD only), the TTLM uses format A (e.g., TID-To-Link Mapping element format A (for intra-AP MLD)) (1103) for link mapping for retransmissions. In an embodiment, a 1 or 2 octet field of link mapping is provided, which is applicable for frame retransmissions belonging to any TID.

In an embodiment, when bit B6 is true (e.g., has a value ‘1’) and bit B7 is also true (e.g., has a value ‘1’) (indicating that links are present across inter-AP MLD as well), TTLM shall use format B (1105) (e.g., TID-To-Link Mapping element format B (for inter-AP MLD) (1105) for link mapping for retransmissions. In an embodiment, a 1 or 2 octet field provides retransmission link mapping from the serving AP MLD (210). This is followed by a TBD length field containing the neighbor AP MLD ID to identify links belonging to it. In an embodiment, a 1 or 2 octet field provides retransmission link mapping from the neighbor AP MLD (410).

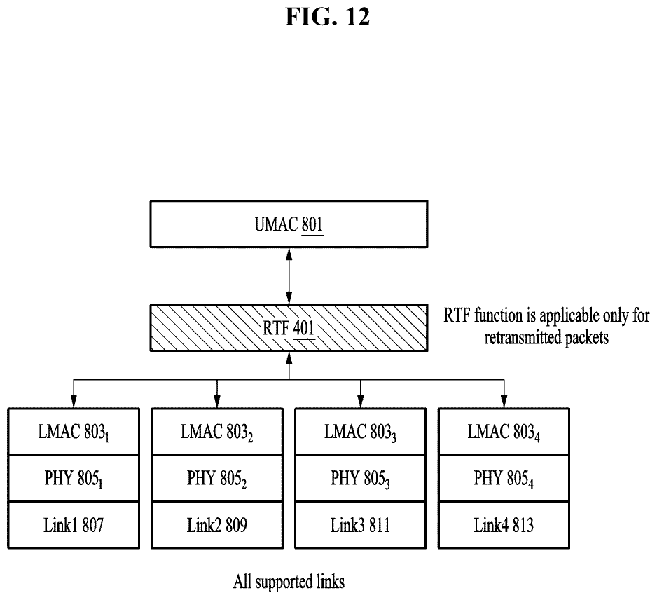

FIG. 12 is a schematic diagram illustrating the RTF entity in the protocol stack of a MLD according to an embodiment. At the upper medium access control (UMAC) (801), the MAC layer data frame retransmission occurs for both individual MAC protocol data units (PDUs) (MPDU) and aggregated MPDUs (A-MPDU). In an embodiment, the RTF entity (401) is positioned between the UMAC (801) and lower medium access control (LMACs) (803) entities. In an embodiment, the RTF entity (401) functions as a new logical or functional entity. For example, the RTF entity (401) decides the link (configured via TTLM) to transmit a new data frame of the TID, with the RTF function being transparent to the RTF entity (401). Further, when the TID of the data frame is intended for retransmission, the corresponding data frame is routed through the RTF entity (401) to a specifically identified suitable link from all the supported and mapped links (807, 809, 811, 813). In an embodiment, a suitable link from all the supported and mapped links is identified using the proposed link analysis and selection mechanism as described herein.

In an embodiment, the functions of the RTF entity (401) can also be realized in UMAC (801).

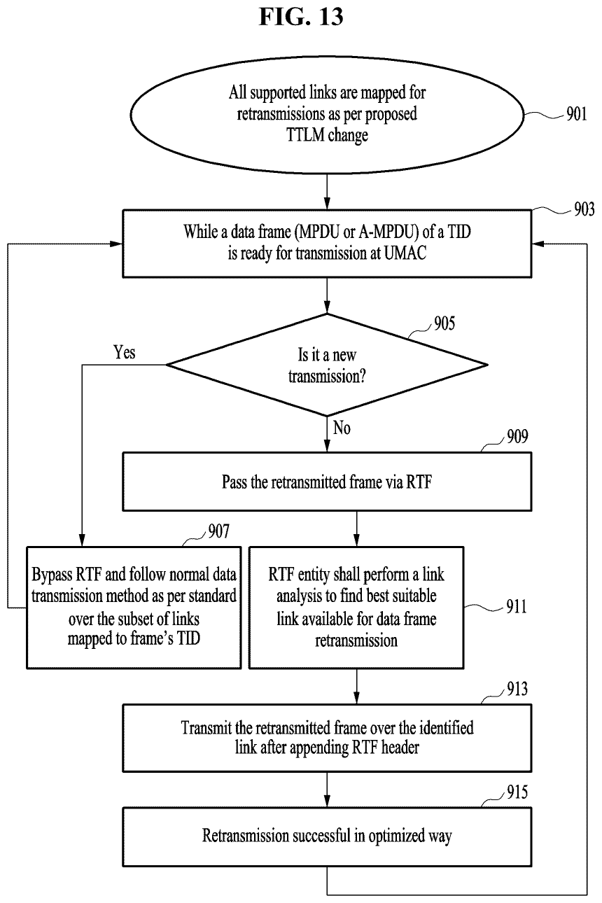

FIG. 13 is the flow diagram that illustrates the method of performing the cross-link retransmission using the RTF entity (401) according to an embodiment. Although one or more operations are described or shown in particular sequential order, in some examples the operations may be rearranged in a different order, which may include performance of multiple operations in at least partially overlapping time periods.

At block 901, the TID-to-Link mapping (TTLM) for retransmissions is configured and is mapped for all the links of the AP MLD (201).

At block 903, the data frame of the TIDs is ready for transmission—e.g., the data frame MPDU or A-MPDU. In an embodiment, the data frame is ready for transmission at the UMAC (801).

At step 905, it is determined whether the transmission is a new transmission or a retransmission. In an embodiment, if the transmission is a new transmission, proceed to block 909. In some examples, if the transmission is a retransmission, proceed to block 907.

At block 907 the RTF entity (401) is bypassed, and a normal data transmission is performed over the subset of links mapped for TIDs when the transmission is determined to be the new transmission. In an embodiment, the method includes determining whether the channel conditions on the current links mapped for new transmissions have fallen below a certain threshold (e.g., a threshold estimation is correlated to a successful transmission condition) so that the same frame can be proactively and simultaneously forwarded to the RTF entity (401). In an embodiment, the same frame can be transmitted via the intra/inter-AP MLD links as well, so that the probability of its quicker and successful reception at the other end is increased without waiting for the actual retransmission upon actual failure. Accordingly, the method is useful for high-priority low-latency traffic, particularly in bad channel conditions.

At block 909, the data frames are passed through the RTF entity (401) when the transmission is determined to be the retransmission.

Furthermore, at block 911, the RTF entity (401) performs the link analysis to find the best suitable link available for data frame retransmission. For example, the RTF entity (401) function uses the link analysis to identify the most suitable and available link for data retransmission (out of all the supported and mapped links configured for this TID for retransmission) so that the probability of successful data retransmission is higher with a lesser number of retransmissions involved. The link analysis can include, but is not limited to, a link's signal strength, a link's signal quality, a link's Signal to Interference and Noise Ratio (SINR), other channel attributes such as Channel Quality Indicator (CQI), a link availability or unavailability due to a power save mode or doze state, channel availability for transmission, etc. Also, in the weak signal area, other aspects can be considered, such as using lower frequency links on 2.4 GHz for larger range and coverage, current transmission buffer load on the link, and the like.

Furthermore, at blocks 913 and 915, the intended frame is retransmitted/transmitted over the identified link (within the standard retransmission parameters and limits) after appending the RTF header to have a higher probability of successful retransmission in a lesser number of transmissions needed.

In an embodiment, during the link analysis, both the inter-AP MLDs (that is, the serving AP MLD (210) and the neighbor AP MLD (410)) must have channel access within the acquired transmit opportunity (TXOP) for simultaneous coordinated transmissions (by both AP MLDs) on the corresponding links. As a result of acquiring the TXOP, the retransmitted/transmitted frames from links via two different AP MLDs arrive within the retransmission window to be reordered properly in the MAC buffer without frame loss. In an embodiment, the RTF entity (401) optimizes the amount of retransmission frames routed through the neighbor AP MLD links to keep the infrastructure delay within limits. Such optimizations ensure there is no buffer overflow at the aggregator MAC by using a link-threshold where the rate or number of retransmitted frames routed through the neighbor AP MLD links shall be equal to or less than this link-threshold.

In an embodiment, a link-offset can be used (in terms of link load signal conditions) so that a link is considered for frame retransmission routing only when the link-offset is better than the current serving AP MLD's best link. In an embodiment, the cross-link frame retransmissions in the inter-AP MLD scenario ensure that all the routed frames via serving AP MLD (210) and neighbor AP MLD's (410) links arrive at the aggregator MAC buffer within the re-ordering window thresholds to avoid frame loss at all times.

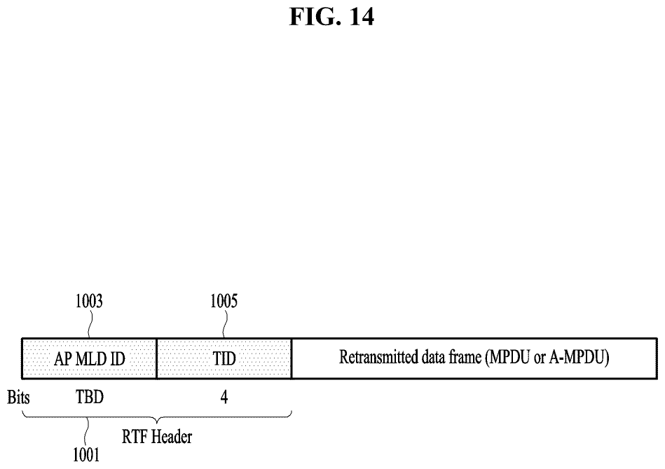

FIG. 14 is a schematic diagram that illustrates the RTF header (1001) included in data frames intended for retransmission according to an embodiment. At a receiver end, the retransmitted frame can come from any of the supported and configured links (all of which are mapped in the same way to every TID for retransmission). Thus, there is a need to identify the correct TID to which the retransmitted frame belongs before forwarding it to the corresponding TID buffer in the UMAC (801).

In an embodiment, though, when the cross-link retransmission is configured across inter-AP MLD links, the TID alone is not sufficient to identify the neighbor AP MLD's TID the retransmitted frame belongs to, as the TID is unique to one AP MLD only. Hence, to identify the TIDs of the AP MLDs, the RTF entity (401) appends the small RTF header (1001) to the retransmitted data frame containing the AP MLD ID (1003) and the TID (1005). With the TID (1005) only, the retransmitted frame is unique for one AP MLD for all links. In an embodiment, when the RTF header includes both the AP MLD ID (1003) and the TID (1005), the retransmitted frame is unique across inter-AP MLDs operating in inter-AP MLD multi-connectivity mode. The RTF header (1001) is appended by the RTF entity (401) of the transmitter (non-) AP MLD (301) side to each retransmitted frame before sending the data frames intended for retransmission on the identified link. At the receiver end, after reading the RTF header (1001) information, the retransmitted frame shall be routed to the correct AP MLD's TID buffer.

One aspect of the present disclosure provides a method for managing data retransmissions in a wireless communication network. This method includes. transmitting a multi-link capability information element to a non-AP MLD, indicating support for cross-link retransmission. Further, the method includes setting a traffic identifier (TID) to-link mapping (TTLM) that maps a TID to all supported links for retransmissions of the AP MLD. Also, the TTLM is applicable for both an intra-AP MLD operation and an inter-AP MLD operation. Further, the method includes transmitting, by the AP MLD, a control information to the non-AP MLD to facilitate a cross-link retransmission. The control information includes all the supported links for retransmissions of the AP MLD.

One aspect of the present disclosure provides a method for managing data retransmissions in a wireless communication network. This method includes transmitting, by an Access Point Multi-Link Device (AP MLD), a multi-link capability information element to a non-AP MLD indicating support for cross-link retransmission. The method includes setting, by the AP MLD, a traffic identifier (TID) to-link mapping (TTLM) that maps a TID to all supported links for retransmissions of the AP MLD, wherein the TTLM is applicable for both an intra-AP MLD operation and an inter-AP MLD operation. The method includes transmitting, by the AP MLD, control information to the non-AP MLD to facilitate a cross-link retransmission, wherein the control information comprises all the supported links for retransmissions of the AP MLD.

In some examples, the transmitting the multi-link capability information element to a non-AP MLD indicating support for cross-link retransmission comprises detecting, by the AP MLD, a support for a cross-link retransmission capability, wherein the cross-link retransmission capability applies to the intra-AP MLD operation and the inter-AP MLD operation. In some examples, the transmitting the multi-link capability information element to a non-AP MLD indicating support for cross-link retransmission comprises transmitting, by the AP MLD, the multi-link capability information element to the non-AP MLD indicating support for the cross-link retransmission.

In some examples, the method comprises segregating, by the AP MLD, a TTLM configuration for a new transmission for the TID with the non-AP MLD and a TTLM configuration for retransmission for a TID associated with the non-AP MLD.

In some examples, the setting of the TTLM comprises determining, by the AP MLD, whether the non-AP MLD supports inter-AP MLD multi-connectivity and cross-link retransmission. The setting of the TTLM comprises transmitting, by the AP MLD, a cross-link retransmission request message to a neighbor AP MLD to request to use supported radio links of the neighbor AP MLD for retransmission of data frames of the non-AP MLD, based at least in part on the non-AP MLD supporting the inter-AP multi-connectivity and the cross-link retransmission. The setting of the TTLM comprises receiving, by the AP MLD, a cross-link retransmission response message from the neighbor AP MLD providing an acceptance to use the supported radio links of the neighbor AP MLD for retransmission of the data frames of the non-AP MLD. The setting of the TTLM comprises performing, by the AP MLD, multi-link re-setup procedure with the non-AP MLD to configure all the supported radio links of the AP MLD and the neighbor AP MLD for performing the retransmissions of the data frames of the non-AP MLD. The setting of the TTLM comprises mapping, by the AP MLD, TID of data frames associated with the non-AP MLD to all supported radio links of the AP MLD and neighbor AP MLD for retransmission of the data frames in the TTLM configuration for the retransmission.

In some examples, the method comprises receiving, by the AP MLD, a cross-link retransmission reject message from the neighbor AP MLD providing a rejection to use the supported radio links of the neighbor AP MLD for retransmission of the data frames of the non-AP MLD. The method comprises refraining, by the AP MLD, from performing the multi-link re-setup procedure with the non-AP MLD based at least in part on receiving the cross-link retransmission reject message.

In some examples, the transmitting of the control information, by the AP MLD, to facilitate cross-link retransmissions comprises determining, by the AP MLD, whether support for the cross-link retransmissions is configured across inter-AP MLD links.

In some examples, the method comprises determining, by the AP MLD, that the cross-link retransmission is configured across the inter-AP MLD links. In some examples, the method comprises adding, by the AP MLD, a retransmission link mapping of the AP MLD, an AP MLD ID of the neighbor AP MLD, and a retransmission link mapping of radio links associated with the neighbor AP MLD in a TTLM control field of the control information.

In some examples, the method comprises determining, by the AP MLD, that the cross-link retransmission is not configured across the inter-AP MLD links. In some examples, the method comprises adding, by the AP MLD, a retransmission link mapping of the AP MLD in a TTLM control field of the control information.

One aspect of the present disclosure provides an AP MLD for managing data retransmission in a wireless communication network. The AP MLD includes a processor and a retransmission handler that is communicatively coupled to the processor. The retransmission handler transmits a multi-link capability information element to a non-AP MLD, indicating support for cross-link retransmission. The retransmission handler also sets a TID to-link mapping (TTLM) to all supported links for retransmissions within the AP MLD. This TTLM is applicable for both an intra-AP MLD operation and an inter-AP MLD operation. The retransmission handler transmits a control information to the non-AP MLD to facilitate a cross-link retransmission. The control information includes all the supported links for retransmissions.

One aspect of the present disclosure provides a non-AP MLD for managing data retransmission in a wireless communication network. The non-AP MLD includes a processor, and a retransmission handler communicatively coupled to the processor. The retransmission handler transmits an indication of support for cross-link retransmission to an AP MLD. The retransmission handler receives control information from the AP MLD to facilitate a cross-link retransmission. The control information includes all the supported links for retransmissions. The retransmission handler appends an RTF header for data frames intended for retransmission. Finally, the retransmission handler retransmits the data frames appended with RTF header in the at least one supported link of all the supported links to the AP MLD.

One aspect of the present disclosure provides a non-statutory computer-readable storage medium storing one or more computer programs comprising instructions to perform a method for managing data retransmission in a wireless network. The method comprises transmitting, by a non-access point (AP) multi-link device (MLD), an indication of support for cross-link retransmission to an AP MLD. The method comprises receiving, by the non-AP MLD, a control information from the AP MLD to facilitate a cross-link retransmission, wherein the control information comprises all supported links of the AP MLD for retransmissions. The method comprises retransmitting, by the non-AP MLD, data frames appended with a retransmission function (RTF) header over at least one supported link of all the supported links of the AP MLD.

One aspect of the present disclosure provides a non-statutory computer-readable storage medium storing one or more computer programs comprising instructions to perform a method for managing data retransmissions in a wireless communication network. This method includes transmitting, by an Access Point Multi-Link Device (AP MLD), a multi-link capability information element to a non-AP MLD indicating support for cross-link retransmission. The method includes setting, by the AP MLD, a traffic identifier (TID) to-link mapping (TTLM) that maps a TID to all supported links for retransmissions of the AP MLD, wherein the TTLM is applicable for both an intra-AP MLD operation and an inter-AP MLD operation. The method includes transmitting, by the AP MLD, control information to the non-AP MLD to facilitate a cross-link retransmission, wherein the control information comprises all the supported links for retransmissions of the AP MLD.

One aspect of the present disclosure provides a non-Access Point Multi Link Device (non-AP MLD) in a wireless network. The non-AP MLD comprises at least one retransmission handler including processing circuitry. The non-AP MLD comprises memory storing instructions that, when executed by the at least one retransmission handler individually or collectively, cause the non-AP MLD to transmit, to an AP MLD, data indicating support for cross-link retransmissions. The memory storing instructions that, when executed by the at least one retransmission handler individually or collectively, cause the non-AP MLD to determine at least one Traffic Identifier (TID) to link mapping table. Some links associated with the at least one TID are dedicated for new transmissions and some links associated with the at least one TID are dedicated for re-transmissions. The memory storing instructions that, when executed by the at least one retransmission handler individually or collectively, cause the non-AP MLD to retransmit, to the AP MLD, data using the links dedicated for re-transmissions.

In some examples, support for cross-link retransmission features includes support for inter-AP MLD multi-connectivity.

In some examples, the links dedicated for transmission and re-transmission can include links from neighbour non-AP MLD based on whether the non-AP MLD supports inter-AP MLD multi-connectivity.

The description of the specific embodiments reveals their general nature, allowing others to modify or adapt them for various applications without deviating from the core concept. Such adaptations and modifications are intended to fall within the scope of the disclosed embodiments. The terminology used is for descriptive purposes only and not limiting. While preferred embodiments are described, those skilled in the art will recognize that modifications can be made within the scope of the described embodiments.

A phrase “at least one of” preceding a series of times, with the terms “and” or “or” to separate any of the times, modifies the list as a whole, rather than each member of the list. The phrase “at least one of” does not require a selection of least one item, rather, the phrase allows a meaning that includes at least one of any one of the items, and/or at least one of any combination of the items, and/or at least one of each of the items. By way of example, each of the phrases “as least one of A, B, and C” or “at least of A, B, or C” refers to Only A, only B, only C, any combination of A, B, and C, and/or at least each of A, B, and C.

What is claimed is:

1. A non-Access Point Multi Link Device (non-AP MLD) in a wireless network, the non-AP MLD comprising:
at least one retransmission handler including processing circuitry; and
memory storing instructions that, when executed by the at least one retransmission handler individually or collectively, cause the non-AP MLD to:
transmit, to an AP MLD, an indication of support for cross-link retransmissions;
receive, from the AP MLD, control information to facilitate a cross-link retransmission, wherein the control information comprises all supported links for retransmissions; and
retransmit, to the AP MLD, data frames appended with a retransmission function (RTF) header over at least one supported link of all the supported links.

2. The non-AP MLD of claim 1, the transmitting, to the AP MLD, data frames appended with a retransmission function (RTF) header over at least one supported link of all the supported links comprises:
receiving, from the AP MLD, an indication for retransmission link mapping of all the supported links for performing the retransmission, wherein the retransmission link mapping is indicated in a traffic identifier (TID)-to-link mapping (TTLM) control field;
determining the at least one supported link from all the supported links for performing the retransmission of the data frames based on monitoring a set of evaluation parameters of the at least one supported link during retransmission;
appending the RTF header for data frames that are intended for retransmission; and
retransmitting, to the AP MLD, the data frames appended with RTF header over the determined at least one supported link.

3. The non-AP MLD of claim 2, wherein the set of link evaluation parameters of the at least one supported link comprises at least one of a radio link signal strength, a radio link signal quality, a radio link's Signal to Interference and Noise Ratio (SINR), channel attributes such as Channel Quality Indicator (CQI), link availability, or channel availability for transmission.

4. The non-AP MLD of claim 1, wherein the appending the RTF header for the data frames that are intended for retransmission comprises:
determining whether the cross-link retransmission is configured across inter-AP MLD links.

5. The non-AP MLD of claim 4, the instructions, when executed by the at least one retransmission handler individually or collectively, further cause the non-AP MLD to:
determine the cross-link retransmission is configured across the inter-AP MLD links; and
append the RTF header that includes an AP MLD identification (ID), and a TID of the data frames for retransmission.

6. The non-AP MLD of claim 4, the instructions, when executed by the at least one retransmission handler individually or collectively, further cause the non-AP MLD to:
determine the cross-link retransmission is not configured across inter-AP MLD links; and
append the RTF header that includes the TID of the data frames for retransmission.

7. An Access Point Multi-Link Device (AP MLD) in a wireless communication network, the AP MLD comprising:
at least one retransmission handler including processing circuitry; and
memory storing instructions that, when executed by the at least one retransmission handler individually or collectively, cause the AP MLD to:
transmit, to a non-AP MLD, a multi-link capability information element indicating support for cross-link retransmission;
set a traffic identifier (TID) to-link mapping (TTLM) that maps a TID to all supported links for retransmissions of the AP MLD, wherein the TTLM is applicable for both an intra-AP MLD operation and an inter-AP MLD operation; and
transmit, to the non-AP MLD, control information to facilitate a cross-link retransmission, wherein the control information comprises all the supported links for retransmissions.

8. The AP MLD of claim 7, wherein to transmit the multi-link capability information element, the instructions that, when executed by the at least one retransmission handler individually or collectively, further cause the AP MLD to:
detect a support for a cross-link retransmission capability, wherein the cross-link retransmission capability applies to the intra-AP MLD operation and the inter-AP MLD operation; and
transmit the multi-link capability information element to the non-AP MLD indicating support for the cross-link retransmission.

9. The AP MLD of claim 7, wherein the instructions that, when executed by the at least one retransmission handler individually or collectively, further cause the AP MLD to:
segregate a TTLM configuration for a new transmission for the TID with the non-AP MLD and a TTLM configuration for retransmission for a TID associated with the non-AP MLD.

10. The AP MLD of claim 7, wherein to set the TTLM, the instructions that, when executed by the at least one retransmission handler individually or collectively, further cause the AP MLD to:
determine whether the non-AP MLD supports an inter-AP MLD multi-connectivity and the cross-link retransmission;
transmit, to a neighbor AP MLD, a cross-link retransmission request message to request to use supported radio links of the neighbor AP MLD for retransmission of data frames of the non-AP MLD, based at least in part on the non-AP MLD supporting the inter-AP multi-connectivity and the cross-link retransmission;
receive a cross-link retransmission response message from the neighbor AP MLD providing an acceptance to use the supported radio links of the neighbor AP MLD for retransmission of the data frames of the non-AP MLD;
perform a multi-link re-setup procedure with the non-AP MLD to configure all the supported radio links of the AP MLD and the neighbor AP MLD for performing the retransmissions of the data frames of the non-AP MLD; and
map the TID of data frames associated with the non-AP MLD to all supported radio links of the AP MLD and neighbor AP MLD for retransmission of the data frames in a TTLM configuration for the retransmission.

11. The AP MLD of claim 10, wherein the instructions that, when executed by the at least one retransmission handler individually or collectively, further cause the AP MLD to:
receive a cross-link retransmission reject message from the neighbor AP MLD providing a rejection to use the supported radio links of the neighbor AP MLD for retransmission of the data frames of the non-AP MLD; and
refrain from performing the multi-link re-setup procedure with the non-AP MLD based at least in part on receiving the cross-link retransmission rejection message.

12. The AP MLD of claim 7, wherein to transmit the control information to facilitate cross-link retransmissions, the instructions that, when executed by the at least one retransmission handler individually or collectively, further cause the AP MLD to:
determine whether support for the cross-link retransmissions is configured across inter-AP MLD links.

13. The AP MLD of claim 12, the instructions that, when executed by the at least one retransmission handler individually or collectively, further cause the AP MLD to:
determine that the cross-link retransmission is configured across the inter-AP MLD links; and
add a retransmission link mapping of the AP MLD, an AP MLD ID of the neighbor AP MLD, and a retransmission link mapping of radio links associated with the neighbor AP MLD in a TTLM control field of the control information.

14. The AP MLD of claim 12, the instructions that, when executed by the at least one retransmission handler individually or collectively, further cause the AP MLD to:
determine that the cross-link retransmission is not configured across the inter-AP MLD links; and
add a retransmission link mapping of the AP MLD in a TTLM control field of the control information.

15. A method for managing data retransmission in a wireless network comprising:
transmitting, by a non-access point (AP) multi-link device (MLD), an indication of support for cross-link retransmission to an AP MLD;
receiving, by the non-AP MLD, a control information from the AP MLD to facilitate a cross-link retransmission, wherein the control information comprises all supported links of the AP MLD for retransmissions; and
retransmitting, by the non-AP MLD, data frames appended with a retransmission function (RTF) header over at least one supported link of all the supported links of the AP MLD.

16. The method of claim 15, wherein the retransmitting the data frames appended with RTF header over at least one supported link to the AP MLD comprises:
receiving, by the non-AP MLD, an indication from the AP MLD for retransmission link mapping of all the supported links for performing the retransmission, wherein the retransmission link mapping is indicated in a traffic identifier (TID)-to-link mapping (TTLM) control field;
determining, by the non-AP MLD, the at least one supported link from all the supported links for performing the retransmission of the data frames based on monitoring a set of evaluation parameters of the at least one supported link during retransmission;
appending, by the non-AP MLD, the RTF header for data frames that are intended for retransmission; and
retransmitting, by the non-AP MLD, the data frames appended with RTF header over the determined at least one supported link to the AP MLD.

17. The method of claim 16, wherein the set of link evaluation parameters of the at least one supported link comprises at least one of a radio link signal strength, a radio link signal quality, a radio link's Signal to Interference and Noise Ratio (SINR), channel attributes such as Channel Quality Indicator (CQI), link availability, or channel availability for transmission.

18. The method of claim 15, wherein the appending the RTF header for the data frames that are intended for retransmission comprises:
determining, by the non-AP MLD, whether the cross-link retransmission is configured across inter-AP MLD links.

19. The method of claim 18, further comprising:
determining, by the non-AP MLD, the cross-link retransmission is configured across the inter-AP MLD links; and
appending, by the non-AP MLD, the RTF header that includes an AP MLD identification (ID), and a TID of the data frames for retransmission.

20. The method of claim 18, further comprising:
determining, by the non-AP MLD, the cross-link retransmission is not configured across inter-AP MLD links; and
appending, by the non-AP MLD, the RTF header that includes the TID of the data frames for retransmission.
